(19) United States
(12) Patent Application Publication
(10) Pub. No.: US 2008/0082742 A1
(43) Pub. Date: Apr. 3, 2008

(54) Storage apparatus, storage apparatus control method, and control apparatus

(75) Inventors: Masami Tashiro, Kawasaki (JP); Toshimitsu Kume, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/788,303

(22) Filed: Apr. 18, 2007

(30) Foreign Application Priority Data
Sep. 29, 2006 (JP) 2006-266515

(51) Int. Cl. G06F 12/00

(52) U.S. Cl. 711/112

(57) ABSTRACT

There is provided a storage apparatus capable of reducing command processing time, a control method of the storage apparatus, and a control apparatus thereof.

A storage apparatus is capable of receiving a write request from an external device, comprising: an FMT position counter 51 that measures a first measurement value concerning the head position on a track of a recording medium; a data reception counter 41 that measures a second measurement value concerning the received data amount of write request data which is data included in the write request from the external device, and a sequential controller 52 that controls data writing operation for the track based on the first and second measurement values measured respectively by the FMT position counter 51 and data reception counter 41.

### BACKGROUND OF THE INVENTION

1. Field of the Invention

The present invention relates to a storage apparatus that performs writing with respect to a medium based on a write instruction issued from an external device, a control method of the storage apparatus, and a control apparatus thereof.

2. Description of the Related Art

Conventionally, in a storage apparatus such as an HDD (Hard Disk Drive) or an optical disk drive, a write command issued from a host is sequentially written onto a medium starting from the head block specified in the write command.

As a prior art relating to the present invention, there is known a disk apparatus capable of preventing delay of read command execution processing as well as improving the efficiency of processing of write commands between which data is duplicated (refer to, e.g., Patent Document 1: Jpn. Pat. Appln. Laid-Open Publication No. 2001-209500).

However, in a storage apparatus comprising a rotating recording medium, write processing cannot be started until the head position reaches the head sector specified by a write command, making it difficult to reduce command processing time. This has prevented the performance of a storage apparatus from being improved.

### SUMMARY OF THE INVENTION

The present invention has been made to solve the above problem, and an object thereof is to provide a storage apparatus capable of reducing command processing time, a control method of the storage apparatus, and a control apparatus thereof.

To solve the above problem, according to a first aspect of the present invention, there is provided a storage apparatus capable of receiving a write request from an external device, comprising: a first measurement section that measures a first measurement value concerning the head position on a track of a recording medium; a second measurement section that measures a second measurement value concerning the received data amount of write request data which is data included in the write request from the external device; and a control section that controls data writing operation for the track based on the first and second measurement values measured by the first and second measurement sections.

In the storage apparatus according to the present invention, the first measurement value is represented by the data amount that can be written, on the track, from the position at which the top of the write request data is to be written to the current head position, and the second measurement value is represented by the amount of the data received among the write request data.

In the storage apparatus according to the present invention, in the case where the first measurement value is less than the second measurement value, the control section performs writing of the write request data that corresponds to the head position.

In the storage apparatus according to the present invention, the data amount is represented by a block.

In the storage apparatus according to the present invention, when determining that the writing of the write request data has been completed, the control section notifies the external device of completion of the processing with respect to the write request.

The storage apparatus according to the present invention, further comprises a third measurement section that measures a third measurement value which is the number of blocks of the write request data that have already been written, wherein the control section stores the first measurement value indicating the position at which the writing is started as a starting first measurement value and, when interrupting the writing of consecutive blocks based on the first and second measurement values, determines the position on the recording medium onto which the data is to be written based on the starting first measurement value and the third measurement value measured by the third measurement section.

The storage apparatus according to the present invention further comprises a fourth measurement section that measures a fourth measurement value which is the number of blocks that have continuously been written starting from the head of the write request data, in which in the case where the fourth measurement value measured by the fourth measurement section becomes more than the requested number of blocks which is the number of blocks of the write request data, the control section determines that writing of the write request data has been completed.

In the storage apparatus according to the present invention, the control section releases data buffer corresponding to the number of continuously-written blocks measured by the fourth measurement section.

The storage apparatus according to the present invention, further comprises a write information storage section that stores information indicating whether writing of each block in the write request data has been completed or not, wherein based on the information stored in the write information storage section, the control section does not perform writing of the block that has already been written.

In the storage apparatus according to the present invention, in the case where the storage apparatus receives a plurality of write requests and physical addresses in the plurality of write requests are consecutive, the control section organizes the data included in the plurality of write requests into one write request data.

In the storage apparatus according to the present invention, the storage apparatus notifies the external device of completion of the processing with respect to the write request according to the order of the write request in the plurality of write requests.

In the storage apparatus according to the present invention, in the case where the position on the recording medium onto which the write request data is to be written spans a plurality of tracks, the first measurement section measures the first measurement value across the plurality of tracks.

In the storage apparatus according to the present invention, in the case where the position on the recording medium onto which the write request data is to be written spans a plurality of tracks, the second measurement section measures the second measurement values for each track.

According to a second aspect of the present invention, there is provided a storage apparatus control method that controls a storage apparatus capable of receiving a write request from an external device, comprising: a measurement step that measures a first measurement value concerning the head position on a track of a recording medium as well as measures a second measurement value concerning the received data amount of write request data which is data included in the write request from the external device; and a control step that controls data writing operation for the track based on the first and second measurement values measured by the measurement step.

According to a third aspect of the present invention, there is provided a control apparatus that controls a storage medium capable of receiving a write request from an external device, comprising: a first measurement section that measures a first measurement value concerning the head position on a track of a recording medium; a second measurement section that measures a second measurement value concerning the received data amount of write request data which is data included in the write request from the external device; and a control section that controls data writing operation for the track based on the first and second measurement values measured by the first and second measurement sections.

According to the present invention, it is possible to reduce the time required to perform command processing.

### BRIEF DESCRIPTION OF THE DRAWINGS

FIG. 1 is a block diagram showing an example of a configuration of a magnetic disk drive according to a first embodiment;

FIG. 2 is a block diagram showing an example of a configuration of a disk controller according to the first embodiment;

FIG. 3 is a flowchart showing an example of operation of write command processing according to the first embodiment;

FIG. 4 is a block diagram showing an example of a configuration of the disk controller according to a second embodiment;

FIG. 5 is a flowchart showing an example of operation of the write command processing according to the second embodiment;

FIG. 6 is a flowchart showing an example of operation of status counter update processing according to the second embodiment;

FIG. 7 is a view showing an example of a table of the write location recording section according to the second embodiment;

FIG. 8 is a view showing an example of a bit map of the write location recording section according to the second embodiment;

FIG. 9 is a view showing a relationship between reception of blocks and writing operation thereof into sectors in a first rotation of a disk medium in terms of time in a concrete example of the write command processing according to the second embodiment;

FIG. 10 is a view showing a relationship between reception of blocks and writing operation thereof into sectors in a second rotation of a disk medium in terms of time in a concrete example of the write command processing according to the second embodiment;

FIG. 11 is a view showing a positional relationship between a track t and a head in a concrete example of the write command processing according to the second embodiment;

FIG. 12 is a view showing the content of a table of the write position recording section in a concrete example of the write command processing according to the present embodiment;

FIG. 13 is a view showing the content of a bit map of the write location recording section in a concrete example of the write command processing according to the second embodiment;

FIG. 14 is a flowchart showing an example of operation of the status counter update processing according to the third embodiment;

FIG. 15 is a flowchart showing an example of operation of first cross-track write command processing according to a fourth embodiment; and

FIG. 16 is a flowchart showing an example of operation of second cross-track write command processing according to the fourth embodiment.

### DETAILED DESCRIPTION OF THE PREFERRED EMBODIMENTS

Embodiments of the present invention will be described below with reference to the accompanying drawings.

### First Embodiment

A configuration of a magnetic disk drive (storage apparatus) according to a first embodiment of the present invention will be described.

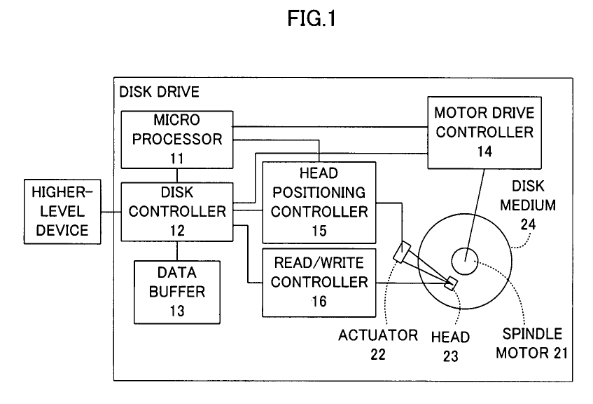

FIG. 1 is a block diagram showing an example of a configuration of the magnetic disk drive according to the present embodiment. The magnetic disk drive includes a microprocessor 11, a disk controller 12, a data buffer 13, a motor drive controller 14, a head positioning controller 15, a read/write controller 16, a spindle motor 21, an actuator 22, a head 23, and a disk medium 24.

The microprocessor 11 controls the disk controller 12, motor drive controller 14, and head positioning controller 15. The motor drive controller 14 controls the spindle motor 21 according to an instruction issued from the microprocessor 11 and disk controller 12, and the spindle motor 21 rotates the disk medium 24. The head positioning controller 15 controls the actuator 22 according to an instruction issued from the microprocessor 11 and disk controller 12, and the actuator 22 moves the head 23.

The disk controller 12 is connected to a higher-level device (host) such as a PC (Personal computer). When a write command is sent from the host to the disk controller 12, data to be written is converted into a signal corresponding to the data by the read/write controller 16 and is written onto the disk medium 24 by the head 23. When a read command is sent from the host to disk controller 12, a signal read out from the disk medium 24 to the head 23 is converted into data by the read/write controller 16 and is sent from the disk controller 12 to the host.

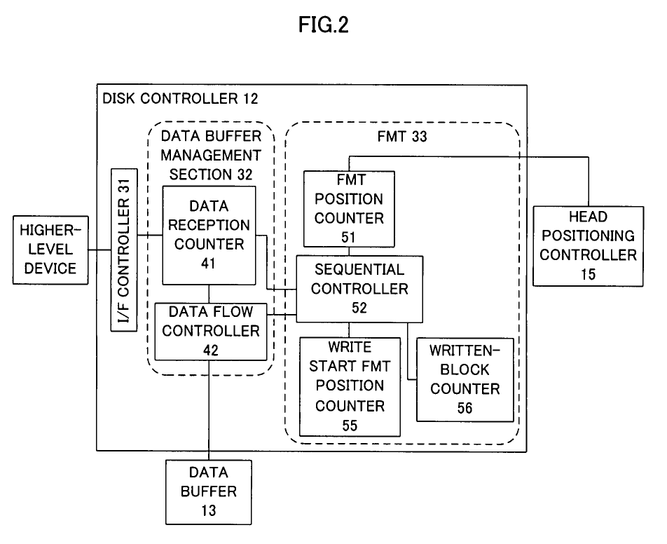

FIG. 2 is a block diagram showing an example of a configuration of the disk controller 12 according to the present embodiment. The disk controller 12 includes an I/F (Interface) controller 31, a data buffer management section 32, and an FMT 33 (Disk Formatter). The data buffer management section 32 includes a data reception counter 41, and a data flow controller 42. The FMT 33 includes an FMT position counter 51, a sequential controller 52, a write start FMT position counter 55, and a written-block counter 56.

The FMT 33 converts an LBA (Logical Block Address) specified by a command from the higher-level device into an FMT position which is a logical address within a range specified by the command and a physical address on the disk medium 24 to perform command processing.

The I/F controller 31 controls the interface between the higher-level device and disk drive. The data reception counter 41 is a counter for representing the amount of data received from the host in units of a block at the write command reception time. The FMT position counter 51 is a counter for representing the current head position as an FMT position which is a logical address starting from the head sector in a write request range specified by the write command. Note that a block corresponds to a sector. The data flow controller 42 performs flow control such as control for the data buffer 13 (ring buffer). The sequential controller 52 performs command processing control.

The write start FMT position counter 55 stores a value of the FMT position counter 51 at which writing operation has started. The written-block counter 56 is a counter representing the number of sectors in which writing operation has been completed.

Operation of write command processing performed when a write command is received from the host will next be described.

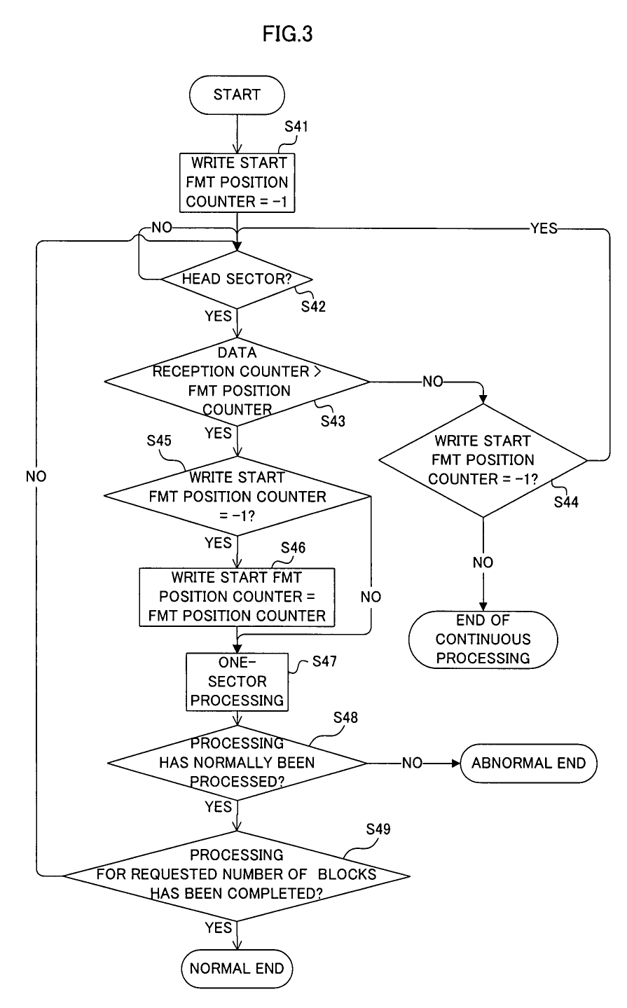

The number of blocks requested in the write command is assumed to be a requested block. FIG. 3 is a flowchart showing an example of operation of the write command processing according to the present embodiment. The sequential controller 52 initializes the value of the write start FMT position counter 55 to −1 and, at the same time, initializes the value of the written-block counter 56 to 0 (S41). The sequential controller 52 then determines whether the current head position is the head sector. In the case where the current head position is not the head sector (NO in S42), the flow returns to step S42, while in the case where current head position is the head sector (YES in step S42), the flow advances to the next step. The sequential controller 52 then determines whether the value of the data reception counter 41 is larger than the value of the FMT position counter 51 (S43).

In the case where the value of the data reception counter 41 is not larger than the value of the FMT position counter 51 (NO in S43), the sequential controller 52 determines the value of the write start FMT position counter 55 is −1. In the case where the write start FMT position counter 55 is −1 (YES in S44), the flow returns to step S42, while in the case where the value of the write start FMT position counter 55 is not −1 (NO in S44), the continuous processing ends and thereby this flow ends.

The continuous processing is processing to continuously write blocks starting from a write start block which is a block corresponding to the write start FMT position. In the case where the continuous processing ends, writing operation of an unwritten block which is a block within a write request range and which has not been written by the continuous processing needs to be performed. Since the range in which the block has been written can be specified by the values of the write start FMT position counter 55 and written-block counter 56, the sequential controller 52 specifies the starting block in the unwritten blocks at the time point when the head position reaches the head sector in the next time after the end of the continuous processing and performs writing operation of unwritten blocks. Further, the sequential controller 52 notifies the host of a write command completion status at the time point when the value of the written-block counter 56 reaches or exceeds the requested number of blocks.

In the case where the value of the data reception counter 41 is larger than the value of the FMT position counter 51 (YES in S43), the sequential controller 52 determines whether the value of write start FMT position counter 55 is −1. In the case where the write start FMT position counter 55 is not −1 (NO in S45), the flow shifts to step S47, while in the case where the write start FMT position counter 55 is −1 (YES in S45), the flow advances to the next step. Then, the sequential controller 52 sets the value of the write start FMT position counter 55 in the FMT position counter 51 (S46).

Then, the sequential controller 52 performs one-sector processing to perform writing operation corresponding to one sector (S47) and determines whether the one-sector processing has normally been carried out. In the case where the one-sector processing has not normally been carried out (NO in S48), this flow abnormally ends, while in the case where the one-sector processing has normally been carried out (YES in S48), the flow advances to the next step. The sequential controller 52 then increments the value of the written-block counter 56 and determines whether the processing for the requested number of blocks has been completed (whether the value of the written-block counter 56 has reached the requested number of blocks). In the case where the processing for the requested number of blocks has not been completed (NO in S49), the flow returns to step S42, while in the case where the processing has been completed (YES in S49), the flow normally ends.

According to the present embodiment, when data is received by a write command, writing operation is performed starting from, among received blocks, a block that can immediately be written, thereby reducing command processing time. Further, by storing the write start position and the number of written-blocks, it is possible to write only unwritten blocks when the head position reaches the head sector in the write request range in the next time and completes the command processing without waiting for the head position to pass through the last sector in the write request range, thereby reducing the command processing time.

### Second Embodiment

In a second embodiment, a magnetic disk drive that records information indicating whether blocks in the write request range have been written or not will be described.

The magnetic disk drive according to the present embodiment has the same configuration as that of the magnetic disk drive according to the first embodiment.

A configuration of the disk controller 12 will next be described.

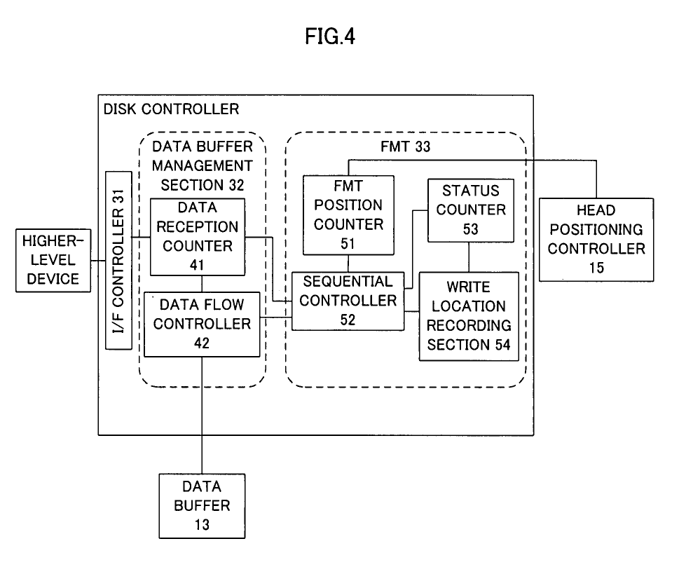

FIG. 4 is a block diagram showing an example of a configuration of the disk controller 12 according to the present embodiment. In FIG. 4, the same reference numerals as those in FIG. 2 denote the same or corresponding parts as those in FIG. 2, and the descriptions thereof will be omitted here. A difference from FIG. 2 is that a status counter 53 and a write location recording section 54 are provided in place of the write start FMT position counter 55 and written-block counter 56.

The write location recording section 54 records blocks that have already been written or blocks that have not yet written among the blocks in the write request range specified by the write command. The status counter 53 is a counter that represents the number of continuous data-written sectors counting from the head sector. Therefore, when the value of the status counter 53 reaches or exceeds the request block number which is the requested number of blocks specified by the write command, the write command processing corresponding to the write request has been completed. Further, the value of the status counter 53 represents the amount (block number) that can be released from among the range of the data buffer 13 secured by the write command. The data flow controller 42 performs flow control such as release of the data buffer 13 according to the value of the status counter 53.

Operation of the write command processing will next be described.

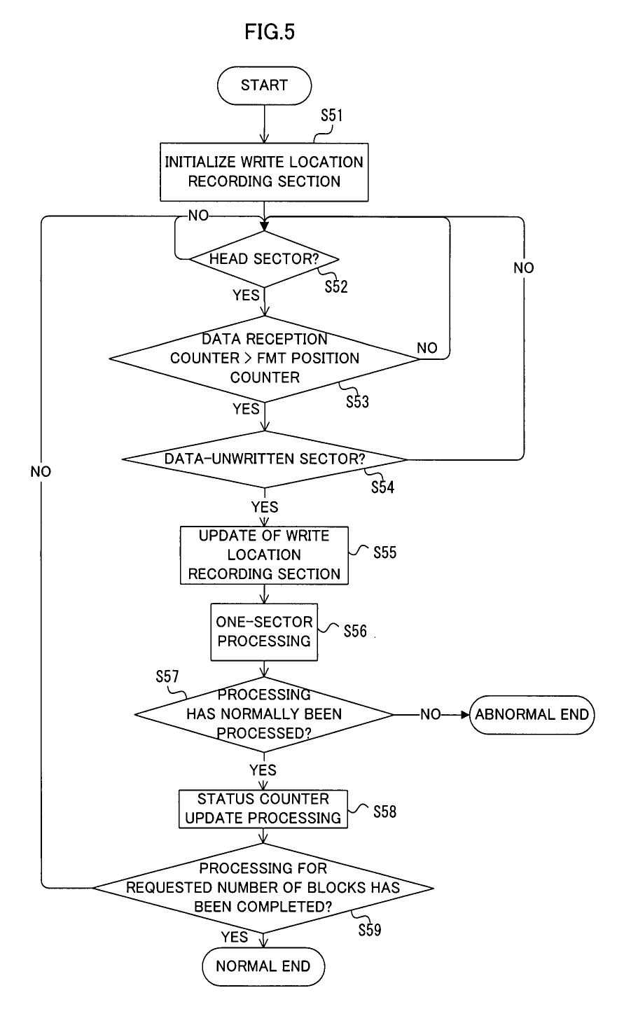

FIG. 5 is a flowchart showing an example of operation of the write command processing according to the present embodiment. The disk controller 12 initializes the write location recording section 54 (S51). Then, the disk controller 12 determines whether the current head position indicates the head sector. In the case where the current head position does not indicate the head sector (NO in S52), the flow returns to step S52, while in the case where the current head position indicates the head sector (YES in S52), the flow advances to the next step. Then, the disk controller 12 determines whether the value of the data reception counter 41 is larger than the value of the FMT position counter 51. In the case where the value of the data reception counter 41 is not larger than the value of the FMT position counter 51 (NO in S53), the flow returns to step S52, while in the case where the value of the data reception counter 41 is larger than the value of the FMT position counter 51 (YES in S53), the flow advances to the next step.

Then, the disk controller 12 refers to the write location recording section 54 to determine whether the current sector is a data-unwritten sector. In the case where the current sector is not a data-unwritten sector (NO in S54), the flow returns to step S52, while in the case where the current sector is a data-unwritten sector (YES in S54), the flow advances to the next step. Then, the disk controller 12 determines that the current sector is a data-written sector, correspondingly updates the content of the write location recording section 54 (S55), and performs one-sector processing to perform writing operation corresponding to one sector (S56). After that, the disk controller 12 determines whether the one-sector processing has normally been carried out. In the case where the one-sector processing has not normally been carried out (NO in S57), this flow abnormally ends, while in the case where the one-sector processing has normally been carried out (YES in S57), the flow advances to the next step.

The disk controller 12 then performs status counter update processing (S58) and refers to the write location recording section 54 to determine whether the processing for the requested number of blocks has been completed (whether the value of the status counter 53 has reached the requested number of blocks). In the case where the processing for the requested number of blocks has not been completed (NO in S59), the flow returns to step S52, while in the case where the processing has been completed (YES in S59), the flow normally ends.

The details of the status counter update processing will next be described.

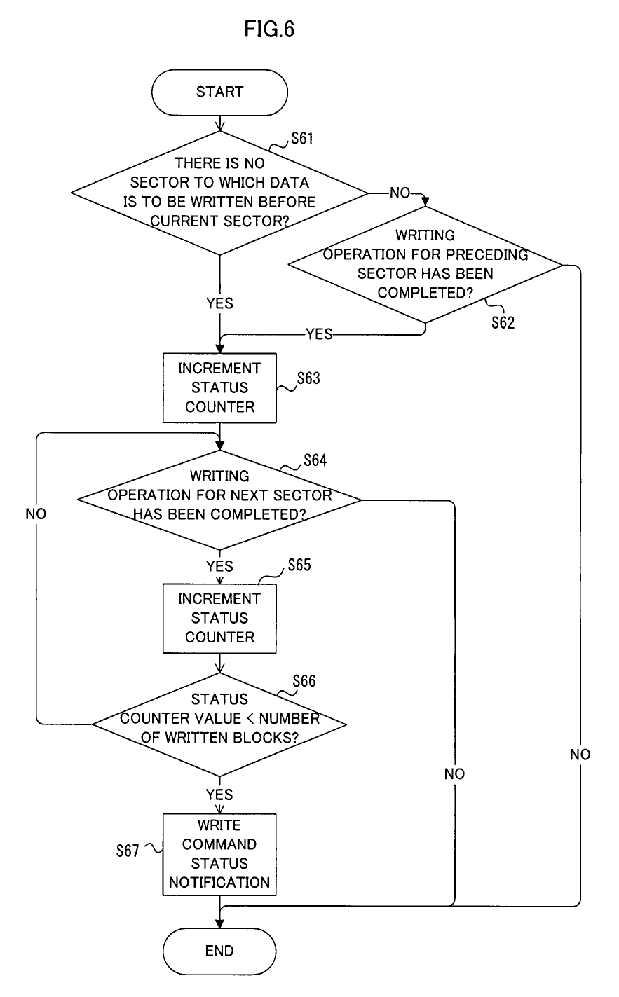

At the start time of the write command processing, the value of the status counter 53 is initialized to 0. The requested number of blocks is set as the tentative requested number of blocks. FIG. 6 is a flowchart showing an example of operation of the status counter update processing according to the present embodiment. The disk controller 12 determines whether there is no sector to which data is to be written before the current sector (S61).

In the case where there is any sector to which data is to be written (NO in S61), the disk controller 12 determines whether writing operation for the immediately preceding sector has been completed. In the case where the writing operation has not been completed (NO in S62), this flow ends, while in the case where the writing operation has been completed (YES in S62), the flow shifts to step S63.

In the case where there is no sector to which data is to be written (YES in S61), the disk controller 12 increments the value of the status counter 53 (S63). The disk controller 12 then determines whether writing operation for the immediately following sector has been completed. In the case where the writing operation has not been completed (NO in S64), this flow ends, while in the case where the writing operation has been completed (YES in S64), the flow advances to the next step. The disk controller 12 then increments the value of the status counter 53 (S65).

Then, the disk controller 12 determines whether “value of the status counter 53<tentative requested number of blocks” is satisfied. In the case where the above condition is not satisfied (NO in S66), the flow returns to step S64, while the above condition is satisfied (YES in S66), the disk controller 12 notifies the host of a write command completion status, and this flow ends.

The details of the write location recording section 54 will next be described. Here, a case where the write location section recording section 54 is in the form of a table and a case where it is in the form of a bit map will be described.

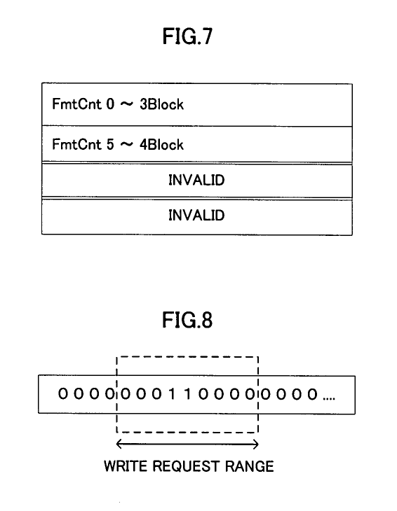

Firstly, a case where the write location recording section 54 is a table that can record up to four unwritten blocks which are blocks that have not been written among the write request range will be described. In step S51, the write request ranges are recorded in the table as unwritten block ranges, and other blocks are initialized as invalid. FIG. 7 is a view showing an example of a table of the write location recording section according to the present embodiment. In this table, FMT positions (FmtCnt)=3 and 4 are sequentially written. Therefore, ranges of “FMT position≦2” (FMT position=2 blocks from 0) and “FMT position≧5” (FMT position=4 blocks from 5) are recorded in the table as unwritten blocks.

Next, a case where the write location recording section 54 is a bit map that can record a bit indicating whether each block has been written (1) or unwritten (0) will be described. In step S51, all bits are initialized to 0. FIG. 8 is a view showing an example of a bit map of the write location recording section according to the present embodiment. In this bit map, FMT positions (FmtCnt)=3 and 4 are sequentially written. Therefore, only the bits of FMT positions of 3 and 4 are recorded as 1.

Next, a concrete example of the write command processing will be described.

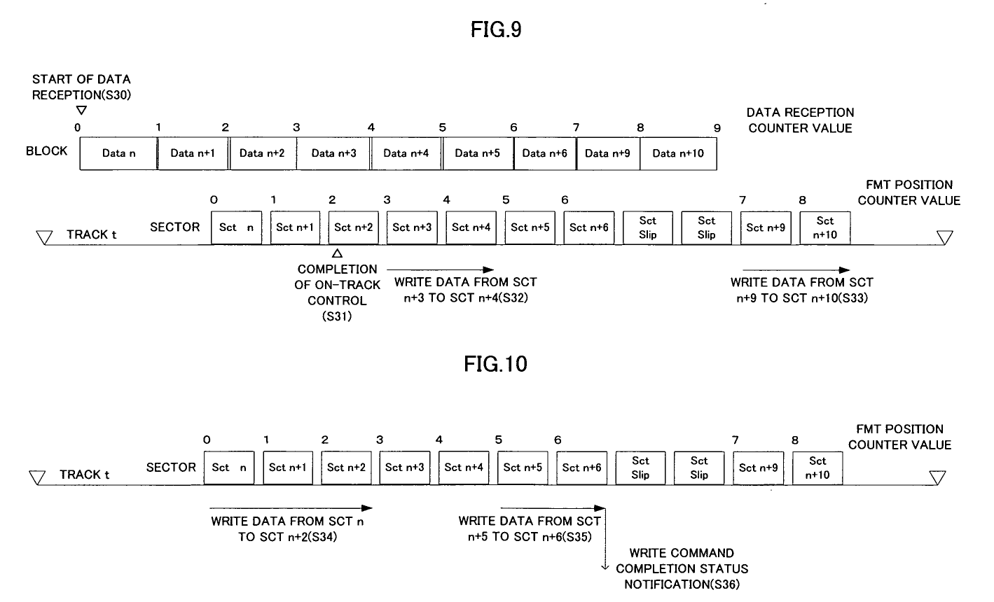

A rotation of the disk medium 24 starting from the time at which the head position is passed through FMT position=0 immediately before a data reception is assumed to be a first rotation, and the next rotation is assumed to be a second rotation. FIG. 9 is a view showing a relationship between reception of blocks and writing thereof into sectors in the first rotation in terms of time in a concrete example of the write command processing according to the present embodiment. FIG. 10 is a view showing a relationship between reception of blocks and writing thereof into sectors in the second rotation in terms of time in a concrete example of the write command processing according to the present embodiment.

In each of FIGS. 9 and 10, the horizontal axis denotes time. Each of upper rectangles marked by “Data x” represents a block of data received from the host. The position of the block corresponds to the time at which the block has been received and increases from the left to right. A numerical value given at the time point when reception of the each block has been completed denotes the value of the data reception counter 41. Each of a lower rectangle marked by “Sct x” denotes a sector. The position of the sector corresponds to a physical address and increases from the left to right. A numerical value given at the top of each sector denotes a value of the FMT position counter 51. An arrow under the sectors denotes writing operation range. A rectangle marked by “Sct Slip” denotes a sector for which writing operation is not performed. x denotes a physical address. In this example, the physical addresses corresponding to the write request range are n to n+6 and n+9 to n+10.

In the first rotation, when starting reception of data from the host, the disk controller 12 initializes the data reception counter 41 to 0 to activate it and sets the head sector to 0 to activate the FMT position counter 51 (S30). When data is received in units of a block, the data reception counter 41 increments the value of the data reception counter 41. After that, at the time point when on-track control (seek) for the head to track t including physical addresses n to n+10 has been completed (at this time, Data n+3 is being received and the head position is in the middle of the Sct n+2), the disk controller 12 compares the value of the data reception counter 41 and value of the FMT position counter 51 (S31). At this time, since the value of the data reception counter 41 is larger than value of the FMT position counter 51 (data reception counter=3, FMT position counter=2), the disk controller 12 starts writing operation of data for sectors starting from the next Sct n+3 (S32).

After that, at the time point when writing operation for Sct n+4 has been completed, the disk controller 12 compares the value of the data reception counter 41 and value of the FMT position counter 51. At this time, since the value of the data reception counter 41 is not larger than value of the FMT position counter 51 (data reception counter=5, FMT position counter=5), the disk controller 12 determines that the data to be written has not been received and stands by without performing data writing operation. Thereafter, at the time point when reception of all data including up to Data n+10 has been completed and the head position has reached the top of the Sct n+9, the value of the data reception counter 41 becomes larger than value of the FMT position counter 51 (data reception counter=9, FMT position counter=7), so that the disk controller 12 starts writing operation of data for sectors starting from the next Sct n+9 (S33) up to Sct n+10 which is the last sector in the write request range.

In the second rotation, at the time point when the head position has reached the top of Sct n, the value of the data reception counter 41 is larger than value of the FMT position counter 51 (data reception counter=9, FMT position counter=0), so that the disk controller 12 starts writing operation of data for sectors starting from the next Sct n (S34) up to Sct n+2 to which data has not been written. Since data-written sectors continues from the head sector at this moment, the status counter 53 updates the value of the status counter 53, and the data flow controller 42 releases the memory area of the data buffer 13 by the amount of the value of the status counter 53.

Thereafter, at the time point when the head position has reached the top of Sct n, the value of the data reception counter 41 is larger than value of the FMT position counter 51 (data reception counter=9, FMT position counter=5), so that the disk controller 12 starts writing operation of data for sectors starting from the next Sct n+5 (S35) up to Sct n+6 to which data has not been written and notifies the host of a write command completion status (S36).

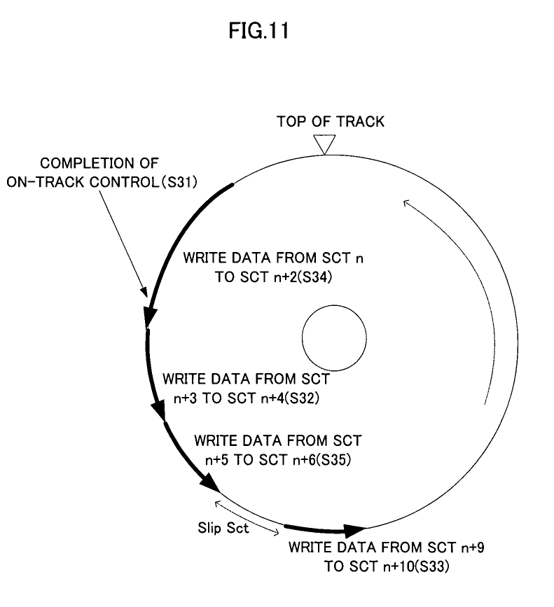

FIG. 11 is a view showing a positional relationship between a track t and a head in a concrete example of the write command processing according to the present embodiment. This illustration shows the positional relationship between the track t and head in the above example shown in FIGS. 9 and 10. The big circle denotes the track t. The head position is moved in a counterclockwise direction with respect to the disk medium 24. Steps S31, S32, S33, S34, and S35 shown in FIG. 11 are the same processing as those shown in FIGS. 9 and 10.

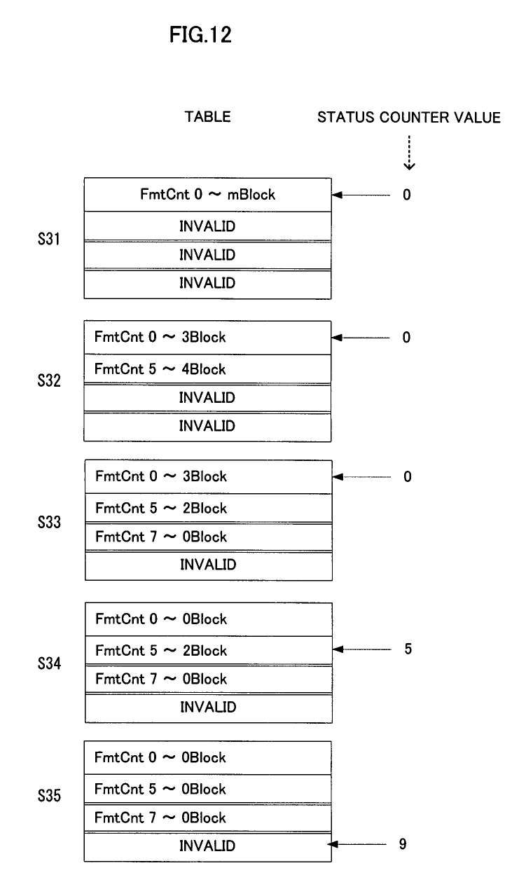

FIG. 12 is a view showing the content of a table of the write location recording section in a concrete example of the write command processing according to the present embodiment. This illustration shows the content of the table at the time points of steps S31, S32, S33, S34, and S35 of FIGS. 9 and 10. A numeral on the right of each table denotes a value of the status counter 53. At the time point of step S31, m blocks starting from FMT position=0 which correspond to the entire write request range are initialized as an unwritten block range and the value of the status counter 53 is initialized to 0. m is the requested number of blocks.

At the time point of completion of the step S32, data has been written in FMT positions=3 and 4, and unwritten block range is updated to become 3 blocks starting from FMT position=0 and m blocks starting from FMT position=5. Subsequently, at the time point of completion of step S33, data has been written in FMT positions=7 and 8, and unwritten block range is updated to become 3 blocks starting from FMT position=0, 2 blocks starting from FMT position=5, and 0 block starting from FMT position=7.

At the time point of completion of the step S34, data has been written in FMT positions=0, 1, and 2, and unwritten block range is updated to become 0 block starting from FMT position=0, 2 blocks starting from FMT position=5, and 0 block starting from FMT position=7. At this time, data has been written to all FMT positions before FMT position=5, so that the value of the status counter 53 becomes 5. Subsequently, at the time point of completion of step S35, data has been written in FMT positions=5 and 6, and unwritten block range is updated to become 0 block starting from FMT position=0, 0 block starting from FMT position=5, and 0 block starting from FMT position=7. At this time, data has been written to all FMT positions before FMT position=9, so that the value of the status counter 53 becomes 9, and the write command completion status notification is made.

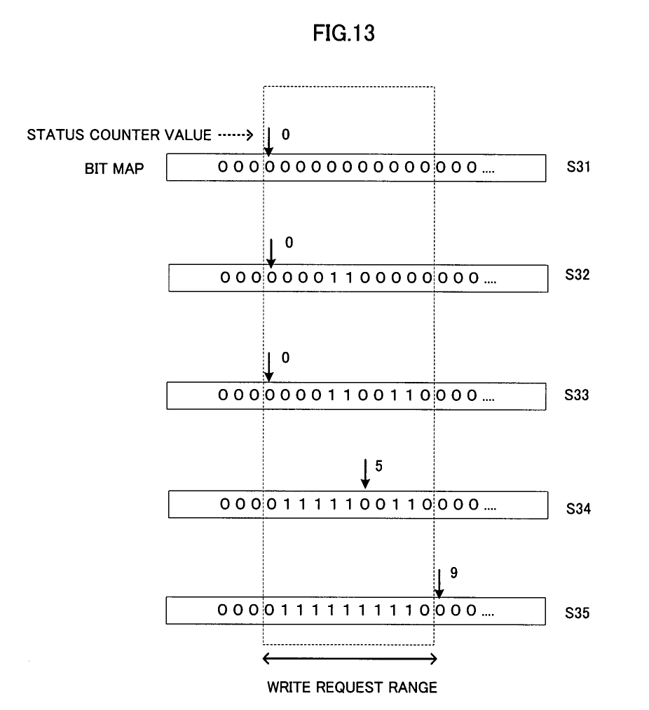

FIG. 13 is a view showing the content of a bit map of the write location recording section in a concrete example of the write command processing according to the present embodiment. This illustration shows the content of the bit map at the time points of steps S31, S32, S33, S34, and S35 of FIGS. 9 and 10. At the time of step S31, FMT positions from 0 to 9 which correspond to the entire write request range are initialized as “0 (unwritten)” and the value of the status counter 53 is initialized to 0.

At the time point of completion of step S32, FMT positions=3 and 4 are updated as “1 (written)”. Thereafter, at the time point of completion of step S33, FMT positions=7 and 8 are updated as “1 (written)”. Thereafter, at the time point of completion of step S34, FMT positions=0, 1, and 2 are updated as “1 (written)”. At this time point, all FMT positions before FMT position=5 become 1 (written), so that the value of the status counter 53 becomes 5. Thereafter, at the time point of completion of step S35, FMT positions=5 and 6 are updated as “1 (written)”. At this time point, all FMT positions before FMT position=9 become 1 (written), so that the value of the status counter 53 becomes 9, and the write command completion status notification is made.

According to the present embodiment, in the case where there exist a plurality of unwritten block ranges in the write request range, it is possible to specify the sector to which data is to be written when the head position reaches the head sector in the write request range, thereby effectively performing the write command processing. Further, the number of blocks that have been written is managed, so that it is possible to notify the host of the completion of data writing operation at the time when the data corresponding to the required number of blocks has been written without waiting for the head position to pass through the last sector in the write request range, thereby reducing the command processing time. Further, even in the case where there remain a plurality of unwritten block ranges after the first continuous processing after reception of a write command, it is possible to specify unwritten blocks so as to effectively perform subsequent writing operation.

### Third Embodiment

In a third embodiment of the present invention, a magnetic disk drive that can effectively perform sequential processing of a plurality of commands will be described.

The magnetic disk drive and disk controller 12 according to the present embodiment have the same configurations as those of the magnetic disk drive and disk controller 12 according to the second embodiment. Further, the operation of the write command processing for one write command is the same as that according to the second embodiment.

With regard to the starting LBA and the number of blocks in a plurality of commands that the magnetic disk drive has sequentially received from the host, in the case where (starting LBA+number of blocks) in one command is equal to the starting LBA in the next write command, that is, in the case where the LBAs in the two commands are consecutive, it is determined that sequential processing can be applied to the two commands. Hereinafter, a plurality of commands to which the sequential processing can be applied is referred to as “sequential command group”. In the sequential processing, blocks in the sequential command group are regarded as blocks in one command and are sequentially processed.

In the case where a conventional magnetic disk drive has received the sequential command group from the host, the magnetic disk drive starts processing after the head position has reached the head LBA in the sequential command group.

In the sequential processing according to the present embodiment, processing is started from a block that can immediately be processed among blocks in the sequential command group. In the write command processing, the requested number of blocks is a sum of requested number of blocks in the sequential command group. The operation of the status counter update processing differs from that of the status counter update processing according to the second embodiment.

The status counter update processing according to the present embodiment will next be described.

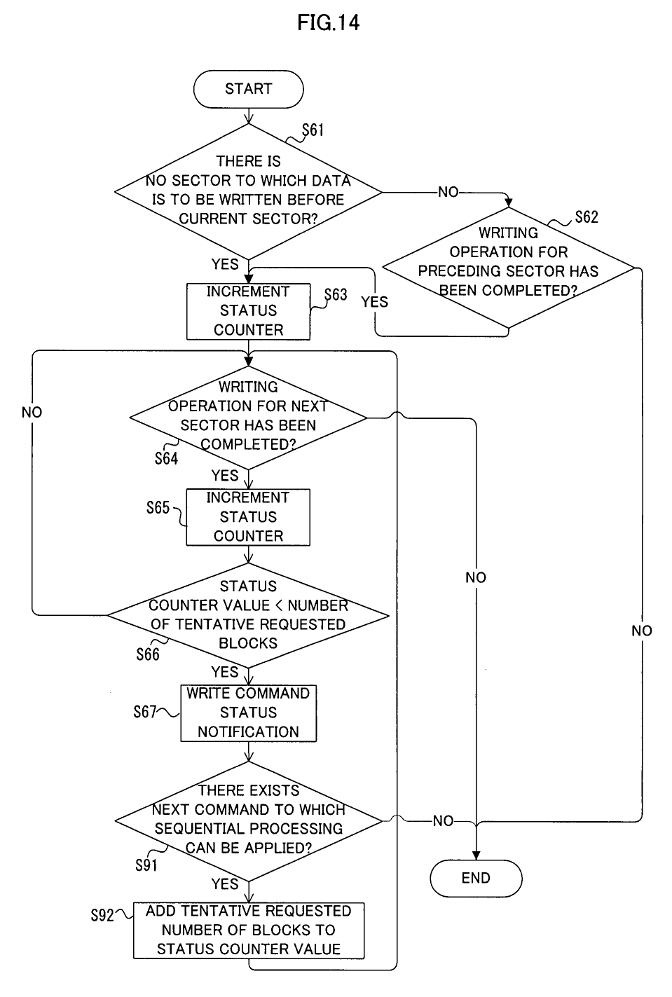

At the start time of the sequential processing, the value of the status counter 53 is initialized to 0 and, at the same time, the number of blocks in the write command to be processed first is set as the tentative requested number of blocks. FIG. 14 is a flowchart showing an example of operation of the status counter update processing according to the present embodiment. In FIG. 14, the same reference numerals as those in FIG. 6 denote the same or corresponding processing as those in FIG. 6, and the descriptions thereof will be omitted here. Steps S61 to S67 are executed in the same manner as in FIG. 6. After completion of step S67, the disk controller 12 determines whether the next command to which the sequential processing can be applied exists. In the case where there does not exist the next command to which the sequential processing can be applied (NO in S91), the flow ends, while in the case where there exists the next command to which the sequential processing can be applied (YES in S91), the disk controller 12 adds the number of blocks in the write command to be processed next to the tentative requested number of blocks (S92), and the flow returns to step S64. That is, in the case where there exists the next command to which the sequential processing can be applied, the disk controller 12 increases the tentative requested number of blocks after making the write command completion notification for one command, so that the status counter 53 can continue counting the number of all blocks in the sequential command group.

According to the status counter update processing according to the present embodiment, the processing is performed starting from a block that can immediately be processed among blocks in the sequential command group, thereby reducing the command processing time. Further, the command processing can be completed without waiting for the head position to reach the FMT position corresponding to the last block in the sequential command group. Further, since the write command status notification to the host is made for each command of the sequential command group in the order of LBA, it is possible to reduce only the command processing time without modifying the procedure on the host side.

### Fourth Embodiment

In a fourth embodiment of the present invention, a magnetic disk drive that effectively performs processing in the case where the write request range specified by a command spans a plurality of tracks will be described.

The magnetic disk drive and disk controller 12 according to the present embodiment have the same configurations as those of the magnetic disk drive and disk controller 12 according to the second embodiment. Further, the operation of the write command processing and status counter update processing is the same as that according to the second embodiment.

Operation of cross-track write command processing which is processing for a write command whose write request range spans a plurality of tracks will be described. As the cross-track write command processing, the disk controller 12 according to the present embodiment executes one of first and second cross-track write command processing. The first cross-track write command processing corrects the FMT position counter for each track, and second cross-track write command processing corrects the data reception counter for each track.

The first cross-track write command processing will first be described.

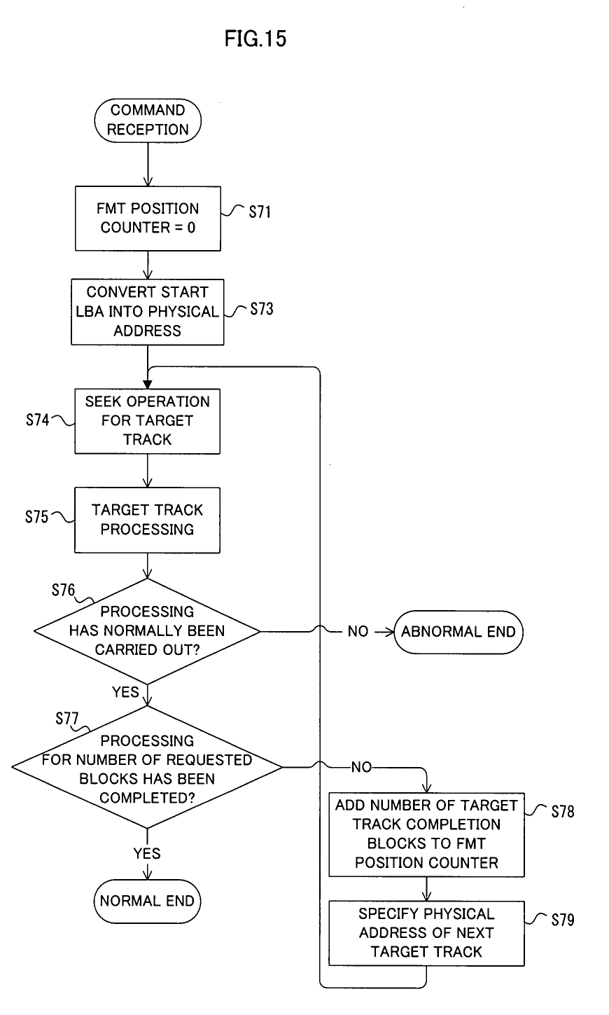

FIG. 15 is a flowchart showing an example of operation of the first cross-track write command processing according to the present embodiment. The disk controller 12 initializes the value of the FMT position counter 51 to 0 (S71) and converts the head LBA specified by the write command into a physical address (S73). Then, the disk controller 12 performs seek operation for a target track which is a track corresponding to the physical address obtained by the conversion (S74). Then, the disk controller 12 performs target track processing which is write command processing for a target track (S75) and determines whether the target track processing has normally been carried out. In the case where the target track processing has not normally been carried out (NO in S76), the flow abnormally ends, while in the case where the target track processing has normally been completed (YES in S76), the flow advances to the next step.

Then, the disk controller 12 determines whether the processing for the requested number of blocks has been completed. In the case where the processing for the requested number of blocks has been completed (YES in S77), the flow normally ends, while the processing for the requested number of blocks has not been completed (NO in S77), the flow advances to the next step. Then, the disk controller 12 adds the number of target track completion blocks which is the number of blocks to which data has been written in the target track to the value of the FMT position counter 51 (S78), specifies the physical address of the next target track (S79), and the flow returns to step S74.

According to the first cross-track write command processing, each of the values of the data reception counter 41 and the FMT position counter 51 is continued across a plurality of tracks. Therefore, a comparison between the value of the data reception counter 41 and the value of the FMT position counter 51 can easily be made as in the case of the write command processing for one track.

The second cross-track write command processing will next be described.

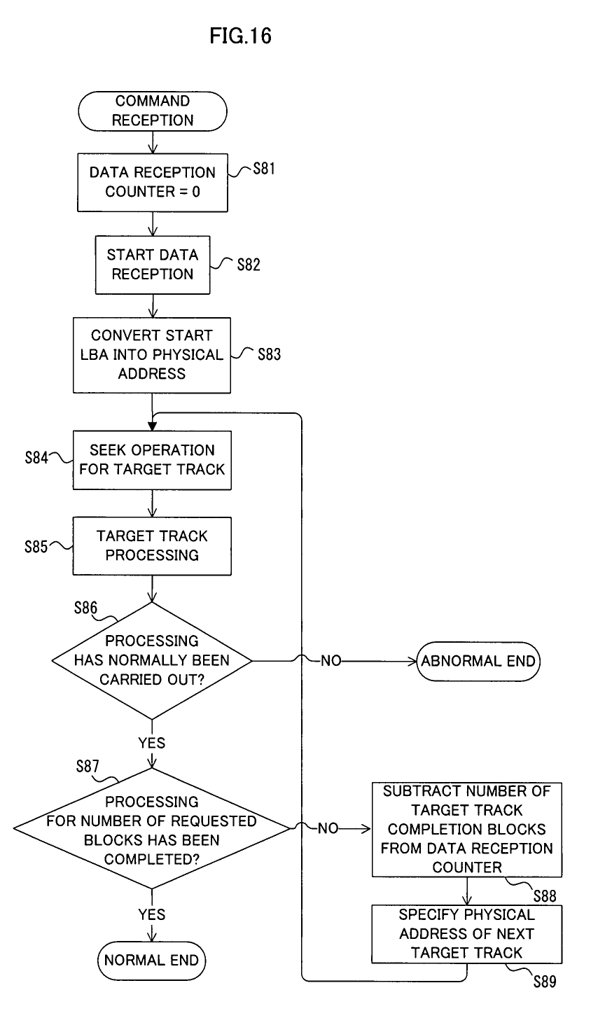

FIG. 16 is a flowchart showing an example of operation of the second cross-track write command processing according to the present embodiment. The disk controller 12 initializes the value of the data reception counter 41 to 0 (S81), starts data reception (S82), and converts the head LBA specified by a write command into a physical address (S83). Then, the disk controller 12 performs seek operation for a target track which is a track corresponding to the physical address obtained by the conversion (S84). Then, the disk controller 12 performs target track processing which is write command processing for a target track (S85) and determines whether the target track processing has normally been carried out. In the case where the target track processing has not normally been carried out (NO in S86), the flow abnormally ends, while in the case where the target track processing has normally been completed (YES in S86), the flow advances to the next step.

Then, the disk controller 12 determines whether the processing for the requested number of blocks has been completed. In the case where the processing for the requested number of blocks has been completed (YES in S87), the flow normally ends, while the processing for the requested number of blocks has not been completed (NO in S87), the flow advances to the next step. Then, the disk controller 12 subtracts the number of target track completion blocks which is the number of blocks to which data has been written in the target track from the value of the data reception counter 41 (S88), specifies the physical address of the next target track (S89), and the flow returns to step S84.

According to the second cross-track write command processing, each of the values of the data reception counter 41 and the FMT position counter 51 starts from 0 in each track. Therefore, a comparison between the value of the data reception counter 41 and the value of the FMT position counter 51 can easily be made as in the case of the write command processing for one track.

According to the present embodiment, the write request range of the write command spans a plurality of tracks, the write command processing can be applied to each track to thereby reduce the entire command processing time.

Although the host issues a write command in the above embodiments, the present invention can be applied to read command processing.

A control section corresponds to the sequential controller in the embodiments. A first measurement section corresponds to the FMT position counter in the embodiments. A second measurement section corresponds to the data reception counter in the embodiments. A first measurement value corresponds to the FMT position counter value in the embodiments. A second measurement value corresponds to the data reception counter value in the embodiments. A third measurement section corresponds to a written-block counter in the embodiments. A third measurement value corresponds to a written-block counter value in the embodiments. A fourth measurement section corresponds to the status counter in the embodiments. A fourth measurement value corresponds to the status counter value in the embodiments.

A measurement step corresponds to the processing of the FMT position counter, data reception counter, written-block counter, and status counter. A control step corresponds to the write command processing in the embodiments.

The disk controller according to the present embodiments can easily be applied to a storage apparatus to thereby improve the performance thereof. Examples of the storage apparatus include a magnetic disk drive, an optical disk drive, a magneto-optical disk drive, and the like.

What is claimed is:

1. A storage apparatus capable of receiving a write request from an external device, comprising:
a first measurement section that measures a first measurement value concerning the head position on a track of a recording medium;
a second measurement section that measures a second measurement value concerning the received data amount of write request data which is data included in the write request from the external device; and
a control section that controls data writing operation for the track based on the first and second measurement values measured by the first and second measurement sections.

2. The storage apparatus according to claim 1, wherein
the first measurement value is represented by the data amount that can be written, on the track, from the position at which the top of the write request data is to be written to the current head position, and
the second measurement value is represented by the amount of the data received among the write request data.

3. The storage apparatus according to claim 2, wherein
in the case where the first measurement value is less than the second measurement value, the control section performs writing of the write request data that corresponds to the head position.

4. The storage apparatus according to claim 1, wherein
the data amount is represented by a block.

5. The storage apparatus according to claim 1, wherein
when determining that the writing of the write request data has been completed, the control section notifies the external device of completion of the processing with respect to the write request.

6. The storage apparatus according to claim 4, further comprising:
a third measurement section that measures a third measurement value which is the number of blocks of the write request data that have already been written, wherein
the control section stores the first measurement value indicating the position at which the writing is started as a starting first measurement value and, when interrupting the writing of consecutive blocks based on the first and second measurement values, determines the position on the recording medium onto which the data is to be written next based on the starting first measurement value and third measurement value measured by the third measurement section.

7. A storage apparatus control method that controls a storage apparatus capable of receiving a write request from an external device, comprising:
a measurement step that measures a first measurement value concerning the head position on a track of a recording medium as well as measures a second measurement value concerning the received data amount of write request data which is data included in the write request from the external device; and
a control step that controls data writing operation for the track based on the first and second measurement values measured by the measurement step.

8. A control apparatus that controls a storage medium capable of receiving a write request from an external device, comprising:
a first measurement section that measures a first measurement value concerning the head position on a track of a recording medium;
a second measurement section that measures a second measurement value concerning the received data amount of write request data which is data included in the write request from the external device; and
a control section that controls data writing operation for the track based on the first and second measurement values measured by the first and second measurement sections.

9. The control apparatus according to claim 8, wherein
the first measurement value is represented by the data amount that can be written, on the track, from the position at which the top of the write request data is to be written to the current head position, and
the second measurement value is represented by the amount of the data received among the write request data.

10. The control apparatus according to claim 9, wherein
in the case where the first measurement value is less than the second measurement value, the control section performs writing of the write request data that corresponds to the head position.

11. The control apparatus according to claim 8, wherein
the data amount is represented by a block.

12. The control apparatus according to claim 8, wherein
when determining that the writing of the write request data has been completed, the control section notifies the external device of completion of the processing with respect to the write request.

13. The control apparatus according to claim 11, further comprising:
a third measurement section that measures a third measurement value which is the number of blocks of the write request data that have already been written, wherein
the control section stores the first measurement value indicating the position at which the writing is started as a starting first measurement value and, when interrupting the writing of consecutive blocks based on the first and second measurement values, determines the position on the recording medium onto which the data is to be written next based on the starting first measurement value and third measurement value measured by the third measurement section.

14. The control apparatus according to claim 11, further comprising:
a fourth measurement section that measures a fourth measurement value which is the number of blocks that have continuously been written starting from the head of the write request data, wherein
in the case where the fourth measurement value measured by the fourth measurement section becomes more than the requested number of blocks which is the number of blocks of the write request data, the control section determines that writing of the write request data has been completed.

15. The control apparatus according to claim 14, wherein
the control section releases data buffer corresponding to the number of continuously-written blocks measured by the fourth measurement section.

16. The control apparatus according to claim 11, further comprising:
a write information storage section that stores information indicating whether writing of each block in the write request data has been completed or not, wherein
based on the information stored in the write information storage section, the control section does not perform writing of the block that has already been written.

17. The control apparatus according to claim 11, wherein
in the case where the control apparatus receives a plurality of write requests and physical addresses in the plurality of write requests are consecutive, the control section organizes the data included in the plurality of write requests into one write request data.

18. The control apparatus according to claim 17, wherein
the control apparatus notifies the external device of completion of the processing with respect to the write request according to the order of the write request in the plurality of write requests.

19. The control apparatus according to claim 8, wherein
in the case where the position on the recording medium onto which the write request data is to be written spans a plurality of tracks, the first measurement section measures the first measurement value across the plurality of tracks.

20. The control apparatus according to claim 8, wherein
in the case where the position on the recording medium onto which the write request data is to be written spans a plurality of tracks, the second measurement section measures the second measurement values for each track.
